(19) United States
(12) Patent Application Publication
(10) Pub. No.: US 2023/0161061 A1
(43) Pub. Date: May 25, 2023

(54) STRUCTURED REPRESENTATIONS OF SUBSURFACE FEATURES FOR HYDROCARBON SYSTEM AND GEOLOGICAL REASONING

(71) Applicant: ExxonMobil Upstream Research Company, Spring, TX (US)

(72) Inventors: Huseyin Denli, Basking Ridge, NJ (US); Stijin De Waele, Flemington, NJ (US); Peng Xu, Annadale, NJ (US); Mary K. Johns, Houston, TX (US)

(73) Assignee: ExxonMobil Upstream Research Company, Spring, TX (US)

(21) Appl. No.: 17/922,836

(22) PCT Filed: Apr. 19, 2021
(86) PCT No.: PCT/US2021/070419

§ 371 Date: Nov. 2, 2022

Related U.S. Application Data
(60) Provisional application No. 62/704,358, filed on May 6, 2020.

(51) Int. Cl. G01V 1/30; G01V 1/34; G01V 99/00

(52) U.S. Cl. CPC G01V 1/302; G01V 1/30; G01V 1/345; G01V 99/005; G01V 2210/64

(57) ABSTRACT

A method and apparatus for utilizing a structured representation of a subsurface region. A method includes obtaining subsurface data for the subsurface region; and extracting the structured representation from the seismic data by: identifying geologic and fluid objects in the seismic images, wherein each object corresponds to a node of the structured representation; and identifying relationships among the identified geologic and fluid objects, wherein each relationship corresponds to an edge of the structured representation. A method further includes determining object attributes, edge attributes, and/or global attributes from the subsurface data. A method further includes inferring information from the structured representation.

### CROSS-REFERENCE TO RELATED APPLICATION

This application claims the benefit and priority of U.S. Provisional Application Ser. No. 62/704,358, filed May 6, 2020 the disclosure of which is incorporated herein by reference in its entirety.

### FIELD

This disclosure relates generally to the field of geophysical prospecting and, more particularly, to prospecting for hydrocarbon and related data processing. Specifically, exemplary embodiments relate to methods and apparatus for improving computational efficiency by using structured representations of subsurface features for hydrocarbon system and geological reasoning.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An important goal of geophysical prospecting is to accurately detect, locate, identify, model, and/or quantify subsurface structures and likelihood of hydrocarbon occurrence. For example, seismic data may be gathered and processed to generate subsurface models. Seismic prospecting is facilitated by acquiring raw seismic data during performance of a seismic survey. The seismic data is processed in an effort to create an accurate mapping (e.g., an image and/or images of maps, such as 2-D or 3-D images presented on a display) of the subsurface region. The processed data is then examined (e.g., analysis of images from the mapping) with a goal of identifying geological structures that may contain hydrocarbons.

Geophysical data (e.g., acquired seismic data, acquired electromagnetic data, reservoir surveillance data, etc.) may be analyzed to develop subsurface models. For example, seismic interpretation may be used to infer geology (e.g., subsurface structures) and hydrocarbon-bearing reservoirs from seismic data (e.g., seismic images or geophysical and petrophysical models). For example, structural interpretation generally involves the interpretation of subsurface horizons (e.g., boundaries between formations), geobodies (e.g., salt anomaly), and/or faults from subsurface images (such as, e.g., pre-stack or partial-stack seismic images or attributes derived from seismic images). Structural interpretation is currently one of the laborious tasks that typically takes months of interpreters' time. As such, structural interpretation is one of the key bottlenecks in the interpretation workflow.

Seismic interpretation is challenged due to the lack of unique mapping of subsurface features and/or fluids from geophysical observations. The observations may also induce ambiguities that obscure the inference of subsurface features, fluid presence, and relationships thereamong. For example, ambiguities in interpretation of plausible relationships may arise from geophysical measurements (e.g., relative amplitudes and phase changes through various offsets or offset stacks). Ambiguities may arise from multiples and other overburden effects, such as shallow events repeated at depth in the seismic images may be interpreted as a boundary between formations. Ambiguities may arise from dimming or attenuation or pull-up or sag of events as a results of inaccuracies in the geophysical models (e.g., acoustic wave velocity). Ambiguities may arise from tuning (amplitude increase where beds thin) or interference of reflections from thin beds. Ambiguities may arise from other coherent noise like acquisition effects or processing errors such as migration sweeps causing events that look like geology (small faults).

While machine learning techniques may provide some structural interpretation assistance, difficulties remain. For example, many modern machine learning approaches, such as deep learning, follow an “end-to-end” design philosophy. As such, emphasis is not placed on the compositional nature of a problem, making minimal a priori representational assumptions and avoiding explicit structures. These approaches work best when data and computing resources are abundantly available. For example, many modern machine learning approaches would attempt to learn the tasks (e.g., low-level geologic classification and segmentation of subsurface images) and extract low level features of the subsurface (e.g., geological fault detection) from seismic images. Such approaches are challenged by reasoning about the relationships among such low-level features, are ill-equipped to learn from small amounts of experience or examples, have difficulty building intuition about a task or environment, and/or fail to make an analogy among tasks, features, and/or problems.

Geologic segmentation (or “structural seismic interpretation”) is one of the laborious tasks of seismic interpretation. Although semantic segmentation using deep learning has been attempted for structural seismic interpretation, the output remains an unstructured collection of labelled pixels. Semantic segmentation using deep learning may identify where an object is located (e.g., a geographical location of a geological fault in a seismic image), but it does not reveal relationships between geologic objects (e.g., geological structural trap “formed by” the fault).

Consequently, many machine learning approaches are not capable of answering questions about a hydrocarbon prospect. Such decision making involves knowledge-intensive reasoning processes, which are conventionally based on a geoscientist's mental images, inductive models, and/or biases.

More efficient equipment and techniques of seismic interpretation with structured representations of subsurface features for geological reasoning would be beneficial.

Background references may include U.S. Pat. No. 9,952,340 B2; U.S. Patent Application Publication Nos. 2014/0118350 A1 and 2019/0064378 A1 and non-patent literature references Anderson et al. (2018) “Bottom-up and top-down attention for image captioning and visual question answering”, 2018 IEEE/CVF Conference on Computer Vision and Pattern Recognition, pp. 6077-6086, doi: 10.1109/CVPR.2018.00636; He et al. (2018) “Mask R-CNN”, pp. 1-12, arXiv: 1703.06870; Johnson et al. (2015) “Image retrieval using scene graphs”, 2015 IEEE Conference on Computer Vison and Pattern Recognition (CVPR), pp. 3668-3678, doi: 10.1109/CVPR.2015.7298990; Karpathy et al. (2015), “Deep visual-semantic alignments for generating image descriptions”, 2015 IEEE Conference on Computer Vision and Pattern Recognition (CVPR), pp. 3128-3137, doi: 10.1109/CVPR.2015.7298932.

### SUMMARY

A method and apparatus for utilizing a structured representation of a subsurface region. A method includes obtaining subsurface data for the subsurface region; and extracting the structured representation from the seismic data by: identifying geologic and fluid objects in the seismic images, wherein each object corresponds to a node of the structured representation; and identifying relationships among the identified geologic and fluid objects, wherein each relationship corresponds to an edge of the structured representation. A method further includes determining object attributes, edge attributes, and/or global attributes from the subsurface data. A method further includes inferring information from the structured representation.

### BRIEF DESCRIPTION OF THE DRAWINGS

So that the manner in which the recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, for the disclosure may admit to other equally effective embodiments and applications.

FIG. 1 illustrates an exemplary hydrocarbon system evidencing play elements.

FIG. 2 illustrates an exemplary graph.

FIG. 3 illustrates the exemplary hydrocarbon system from FIG. 1 with nodes and edges identified.

FIG. 4 illustrates an exemplary graph that is representative of the exemplary hydrocarbon system from FIG. 1.

FIG. 5 illustrates sub-procedures that may be utilized to extract information from input seismic images to generate structured representations of the objects and their relationships.

FIG. 6 illustrates an exemplary ontology for the exemplary graph from FIG. 4.

FIG. 7 illustrates an exemplary building block of a characteristic graph network.

FIG. 8 illustrates a functional diagram of a system that utilizes a structured representation model to simultaneously identify geologic objects and relationships thereamong.

FIG. 9 illustrates structured representation models utilizing embeddings to represent geologic objects and relationships thereamong.

FIG. 10 illustrates a functional diagram of a geological reasoning system utilizing structured representation models.

FIG. 11 illustrates a block diagram of a seismic data analysis system upon which the present technological advancement may be embodied.

### DETAILED DESCRIPTION

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +10% variation. The term “nominal” means as planned or designed in the absence of variables such as wind, waves, currents, or other unplanned phenomena. “Nominal” may be implied as commonly used in the fields of seismic prospecting and/or hydrocarbon management.

The term “simultaneous” does not necessarily mean that two or more events occur at precisely the same time or over exactly the same time period. Rather, as used herein, “simultaneous” means that the two or more events occur near in time or during overlapping time periods. For example, the two or more events may be separated by a short time interval that is small compared to the duration of the overall operation. As another example, the two or more events may occur during time periods that overlap by about 40% to about 100% of either period.

The term “seismic data” as used herein broadly means any data received and/or recorded as part of the seismic surveying process, including particle displacement, velocity, and/or acceleration, pressure, reflection, shear, and/or refraction wave data. “Seismic data” is also intended to include any data or properties, including geophysical properties such as one or more of: elastic properties (e.g., P and/or S wave velocity, P-Impedance, S-Impedance, density, attenuation, anisotropy, and the like); seismic stacks (e.g., seismic angle stacks); compressional velocity models; and porosity, permeability, or the like, that the ordinarily skilled artisan at the time of this disclosure will recognize may be inferred or otherwise derived from such data received and/or recorded as part of the seismic surveying process. Thus, the disclosure may at times refer to “seismic data and/or data derived therefrom,” or equivalently simply to “seismic data.” Both terms are intended to include both measured/recorded seismic data and such derived data, unless the context clearly indicates that only one or the other is intended.

The term “geophysical data” as used herein broadly includes seismic data, as well as other data obtained from non-seismic geophysical methods such as electrical resistivity.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) is represented by picture elements (pixels). Such numerical representations may be shape-based or functional forms in addition to, or in lieu of, cell-based numerical representations.

As used herein, “hydrocarbon management” or “managing hydrocarbons” includes any one or more of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.).

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries. For example, a seismic survey may be conducted to acquire the initial data (noting that these and other embodiments may also or instead include obtaining other geophysical data in addition or, or instead of, seismic data—such as obtaining electrical resistivity measurements). In these and other embodiments, models may be utilized to generate synthetic initial data (e.g., computer simulation). In some embodiments, the initial data may be obtained from a library of data from previous seismic surveys or previous computer simulations. In some embodiments, a combination of any two or more of these methods may be utilized to generate the initial data.

The term “label” generally refers to identifications and/or assessments of correct or true outputs provided for a given set of inputs. Labels may be of any of a variety of formats, including text labels, data tags (e.g., binary value tags), pixel attribute adjustments (e.g., color highlighting), n-tuple label (e.g., concatenation and/or array of two or more labels), etc.

The term “geological reasoning” refers to a variety of tasks related to identifying and/or localizing hydrocarbon system elements (e.g., trap, reservoir, seal, migration pathways, water-hydrocarbon contact surfaces, source rock etc.), inferring relationships among hydrocarbon system elements, and/or quantifying hydrocarbon accumulations, or probabilities thereof, in subsurface regions. Such tasks may include question answering, decision making, assigning ranking, assessing probability, and other reasoning tasks that ultimately facilitate hydrocarbon management.

If there is any conflict in the usages of a word or term in this specification and one or more patent or other documents that may be incorporated herein by reference, the definitions that are consistent with this specification should be adopted for the purposes of understanding this disclosure.

One of the many potential advantages of the embodiments of the present disclosure is that structured representations of subsurface features for geological reasoning may efficiently analyze a hydrocarbon system. Under conventional approaches to hydrocarbon system interpretation, a domain expert (such as a geoscientist or an interpreter) extracts information from available subsurface data and subjectively synthesizes the extracted information based on his/her knowledge. However, the amount of available information could be overwhelming for one expert, or even a team of experts. Embodiments of the present disclosure may more optimally extract and combine information to reason about a hydrocarbon system more effectively.

Another potential advantage includes identification of geologic and/or fluid elements from seismic data based on geological and/or petrological relationships. For example, relationships may include spatial (geographical) relationships, stratigraphic relationships, depositional, geomechanical (faulting) relationships, relative timing and/or age, and migration pathway. In some embodiments, identified and connected elements may be utilized for reasoning about geological and petroleum systems.

Another potential advantage includes the ability to not only detect geologic objects, but also to identify relationships among the detected geologic objects. These geological relationships can be complex expressions of subsurface physics (e.g., hydrocarbon migrates from source to reservoir through hydrocarbon migration pathways (e.g., fault) under the buoyancy forces). Embodiments of the present disclosure may provide enhanced information to reason about a hydrocarbon system more effectively.

Other potential advantages will be apparent to the skilled artisan with the benefit of this disclosure. Embodiments of the present disclosure can thereby be useful in the discovery and/or extraction of hydrocarbons from subsurface formations.

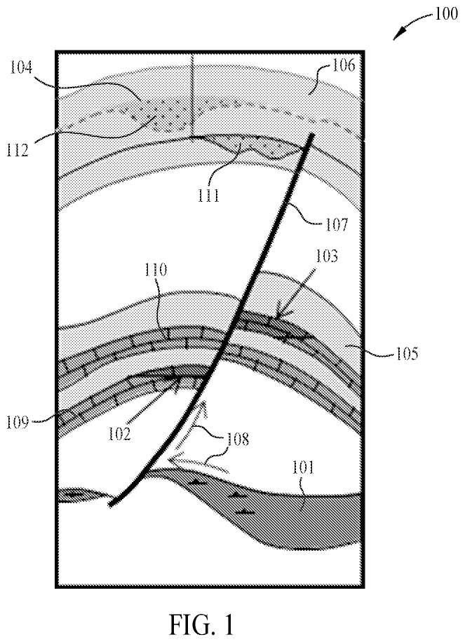

Although seismic images are generally unstructured data represented by a set of pixels (e.g., pre-stack or partial-stacked seismic image patches), geoscientific knowledge (e.g., as conveyed in a seismic image) is compositional in nature and has structure. Play elements contained in a seismic image are organized by physics of the Earth. For example, the exemplary hydrocarbon system 100 illustrated in FIG. 1 evidences play elements, such as source 101, traps 102, 103, 104, seals 105, 106, fault 107, migration path 108, and reservoirs 109, 110,111, 112. A geoscientist typically utilizes mature geoscientific knowledge to identify such play elements and establish relationships thereamong. For example, geoscientific knowledge may provide expectations (e.g., spatial relationships) such as (1) a seal is above a trap, (2) a source is below a reservoir, (3) fluid contacts wrap around the trap, (4) the reservoir is co-located in the trap, and (5) the reservoir is connected across the fault. When interpreting new information and/or analyzing a new hydrocarbon prospect, a geoscientist either fits new observations into prior structured representations (e.g., geoscience ontology), or he/she adjusts the structure of the representations to accommodate the new observations. The structured representations may thereby provide valuable inductive biases to enhance the reasoning process.

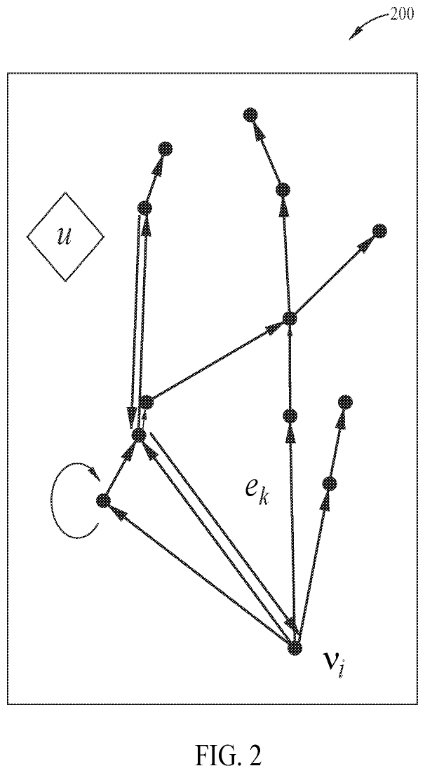

Embodiments disclosed herein construct and/or utilize structured representations for geologic objects (e.g., play elements, geological features, and/or fluids) as contained in seismic images. These structured representation may be based on graphs and/or embeddings. For example, embodiments disclosed herein may utilize graphs and/or embeddings to represent and/or employ geoscientific knowledge. An exemplary graph 200 is illustrated in FIG. 2. In graph theory, a graph structure includes a set of objects. Some pairs of the objects are in some sense “related.” The objects are referred to as vertices (more generally called “nodes”). As used herein, “node” may generally refer to a structured representation of an object, such as a vertex in a graph or a point in an embedding space. A vertex vᵢ is illustrated in FIG. 2. Each of the related pairs of vertices define a link (more generally called an “edge”). As used herein, “edge” may generally refer to a structured representation of a relationship, such as a link in a graph or a connection in an embedding space. An edge eₖ is illustrated in FIG. 2. The edges may be directed or undirected, and any pair of vertices may have multiple edges. All of the edges illustrated in FIG. 2 are directed. The direction of an edge may thereby define a sender node (or source node) and a receiver node. FIG. 2 also illustrates a global (i.e., graph-level) attribute u. Generally, attributes may be encoded as a vector, set, or another graph. Vertices and edges may also have associated attributes.

In some embodiments, geologic object attributes and their relationships may not be uniform. For example, source 101 in FIG. 1 may be a three-dimensional volume object, while fault 107 may be a three-dimensional surface object. Thus, attribute types (e.g., length, surface, or volume) may depend on the object type. Some embodiments may include systems and methods configured to accept and/or process heterogeneous object types.

Embodiments disclosed herein construct and/or utilize graphs (e.g., knowledge graphs, semantic graphs, etc.) as explicit structured representations of objects and their relationships. In some embodiments, the graph representations may be deterministic. In some embodiments, the graph representations may be probabilistic (e.g., the relationships are based on a probability distribution).

Embodiments disclosed herein may identify geologic objects by class and/or instance. The identification of an object refers to localization, classification, and/or segmentation (mask) of the object within an image (or image patch), for example by representation in a coordinate system. In some embodiments, a representation (e.g., a graph) of an object may include a set of nodes. In some embodiments (e.g., fluid indicator analysis), an individual pixel may be a node, and output of the structural representation may group (or associate) a set of pixels together (e.g., instance segmentation). Moreover, relationships between nodes (e.g., a trap is “formed by” a fault) may be represented by the edges of a graph. The relationships may include spatial relationships (positional descriptors), or geological and/or petrological (or other geoscientific) relationships.

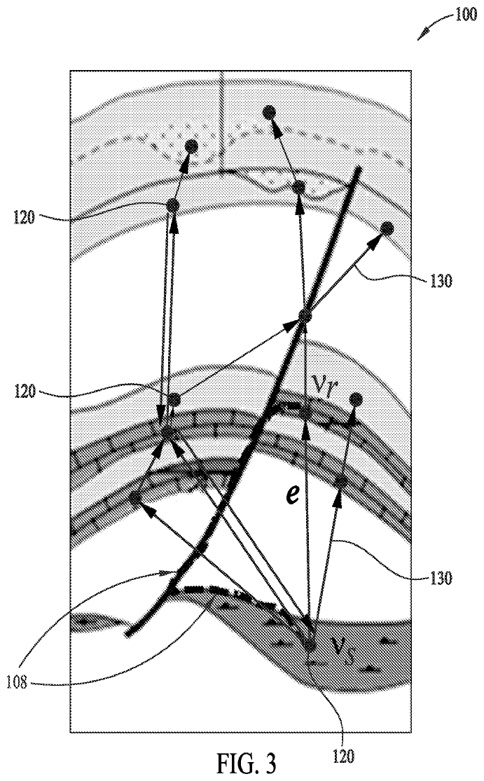

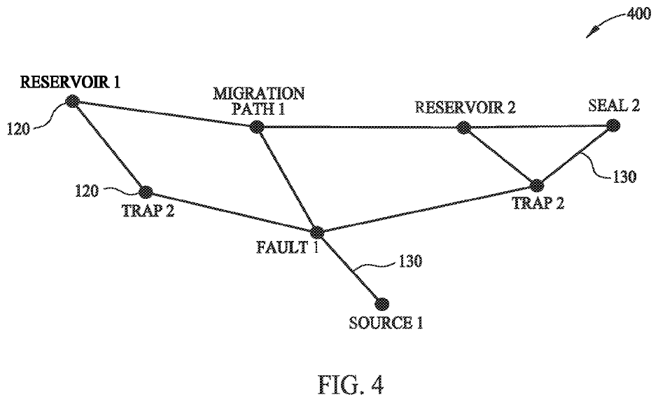

In some embodiments, any geologic object of interest (e.g., faults, facies, fluid indicator, reservoir trap, source rock, and other hydrocarbon play elements) from a seismic image may be represented by a node or a set of nodes. FIG. 3 illustrates the exemplary hydrocarbon system 100 from FIG. 1 with nodes 120 and edges 130 identified. Collectively, the nodes 120 and edges 130 make up a graph that is representative of the hydrocarbon system 100. For example, FIG. 4 illustrates an exemplary graph 400 that is representative of the exemplary hydrocarbon system 100.

Graphs geometrically represent objects as nodes and the relationships between objects as edges. In an embedding representation, objects and relationships may be represented as vectors and/or sets of vectors. In other words, graph embeddings transform properties represented in graphs to vectors or a sets of vectors. Embeddings capture the graph topology, vertex-to-vertex relationship, and other relevant information about graphs, subgraphs, and vertices. For example, the connectivity between objects or attributes of objects may be represented with a distance metric (or adjacency metric, or similarity comparison functional). An embedding may cluster nodes to represent an object using a classification metric. For example, a set of nodes belonging to an instance of a fault may be classified together. Further, another set of nodes belonging to another instance of a fault may be classified mutually together, but distinct from the first set.

Some embodiments disclosed herein construct and/or utilize embeddings as implicit structured representations of the object relationships. For example, a connectivity between two objects may be determined by a distance in the embedding space of the two objects. The type of connectivity (or the relationship between those objects) may be determined by a decoder neural network which takes in the values of embeddings and outputs the type of relationship between the connected objects.

In some embodiments, structured representations of play elements and their relationships may be extended to other knowledge bases (e.g., stratigraphy knowledge base) by creating new edges to associated information. In some embodiments, a method of graph analytics (e.g., graph networks) may utilize structured data (e.g., a graph with objects and/or edges) to retrieve information to support hydrocarbon management decisions and/or infer new information from the structured representations.

In embodiments of this disclosure, graphs and/or embeddings represent relational (or structured) information in visual or text forms. For example, knowledge graphs (also so-called semantic graphs) may be utilized to capture information about interactions among subsurface objects (e.g., geologic objects such as fault, trap and fluid indicator) detected from seismic images. In some embodiments, an unstructured input (e.g., seismic image or map) may be utilized to produce a structured representation of objects in the input (e.g., subsurface objects in the image). In some embodiments, identified and/or connected subsurface objects may be linked to other subsurface knowledge bases (e.g., stratigraphic knowledge base, formation knowledge base, and/or petrophysical interpretations based on log data) by expanding graph connectivity. In some embodiments, a structured representation model may learn to simultaneously identify many, most, or all of the elements that make up the subsurface or petroleum system and link these elements together. In some embodiments, such a representation of a petroleum system may be utilized for downstream tasks, including, but not limited to: instance segmentation, analog recommendation, reasoning about Direct Hydrocarbon Indicators (“DHI”)/Fluid presence, geological reasoning (e.g., geological question answering), prospect rating and ranking, and/or connecting geoscientific knowledge (e.g., geological, geophysical, petrophysical) with and domain experts' knowledge (e.g., as captured by interacting with the expert or recorded in the existing documents). Embodiments of the present disclosure can thereby be useful in the discovery and/or extraction of hydrocarbons from subsurface formations.

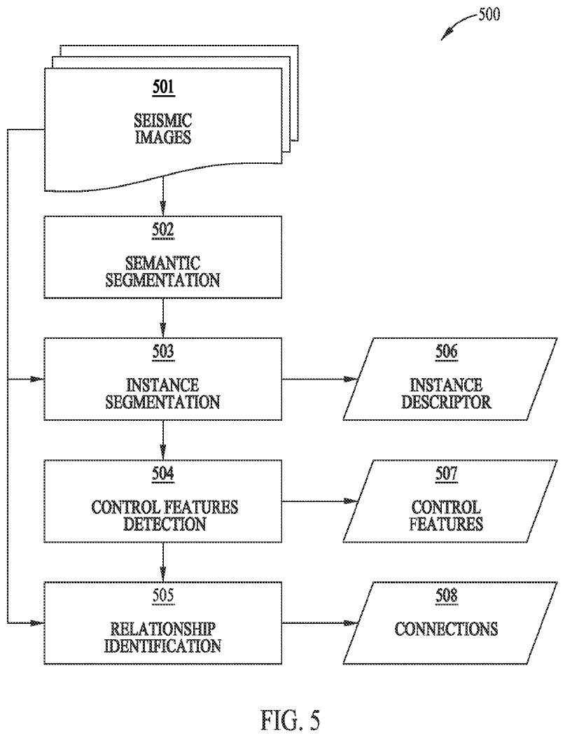

In some embodiments, utilizing graphs and/or embeddings to represent relational (or structured) information in visual or text forms may involve one or more sub-procedures. For example, as illustrated in FIG. 5, multiple sub-procedures 500 may be utilized to extract information from input seismic images 501 to generate structured representations of the objects and their relationships.

At block 502, semantic segmentation may be utilized to generate pixel-level classification (e.g., semantic segmentation in a machine learning field, or concept segmentation in a knowledge representation field) of geologic objects (e.g., faults, facies, environment of deposition (EOD), DHI, fluid-fluid contact surfaces, salt, channels, trap, seal, etc.). For example, faults may be marked as class 1, and background may be marked as class 0. In some embodiments, semantic segmentation may be utilized to generate pixel-level classification of geologic objects that are related with hydrocarbon generation and retention, such as the play elements of hydrocarbon system 100 (see FIG. 1). In some embodiments, methods based on machine learning algorithms may delineate objects of interest in a pixelated representation. Such algorithms are described in co-pending U.S. Patent Application Publication No. 2019/0064378. The machine learning algorithms may provide input supplemental to seismic images 501.

At block 503, instance segmentation may be utilized to group pixels into separate instances of a class. For example, pixels belonging to each instance of a fault may be segmented into fault number 1, fault number 2, fault number 3, etc.

At block 504, control features detection may be utilized to identify the geologic objects by representative features. For example, a fault may include features of a fault center (or centroid) and two fault ends (or boundaries). Therefore, fault number 1 may be identified by its center and end (boundary) control features. As another example, a fault may have attributes such as throw and thickness. Therefore, fault number 1 may be described by its throw and thickness control features.

At block 505, relationship identification may be utilized to connect each object to other objects. For example, a fault may be connected to dislocated sedimentary layers. As another example, a fault may be connected to a structural trap. As another example, a structural trap may be connected to DHI presence next to the fault. As another example, a structure trap may be connected to a plausible migration pathway or pathways. Other examples of geological relationships may include geological age (relative age) or timing (e.g., trap formed before charge; faults formed after trap filled potentially causing leak; burial history consistent with hydrocarbon formation; salt movement before hydrocarbon migration; crosscutting among faults or channels. Additional examples of geological relationships may include connectivity (pressure communication), such as a sand facies in contact with another sand facies (e.g., across a fault channel, or eroded into one another). Still other examples of geological relationships may include charge, such as potential paths between source and reservoir, or between multiple traps, or between trap and other reservoirs. Yet additional examples of geological relationships include spatial relationships beyond geographical relationships of the hydrocarbon play elements. Moreover, geological relationships may include multiple accumulations of hydrocarbon along a fault as evidence of hydrocarbon leak through the fault (e.g., leak to seafloor as seeps, or shallow gas). Additionally, geological relationships may include evidence of oil/water contact (with amplitude terminations, flat spot, etc.), such as down dip from a hydrocarbon anomaly. Another geological relationship may include evidence of reservoir thinning (and potential trap), such as up dip from a hydrocarbon anomaly and contact.

Output of the various sub-procedures for structured representation (e.g., based on a graph or embedding) of geologic objects on the seismic image may include instance descriptor 506 as object or node attributes in the graph. For example, instance segmentation may output for each instance various instance descriptors, such as class, ID, a set of pixels from the seismic images and pixel probabilities belonging to the class, bounding box for localization of the instance, etc. Output of the various sub-procedures may also include control features 507. Output of the various sub-procedures may also include object control features 507 (e.g., nodes 120 illustrated in FIG. 4) as object or node attributes in the graph. Output of the various sub-procedures may also include connections 508 (e.g., edges 130 illustrated in FIG. 4) as attributes of edges in the graph.

Embodiments disclosed herein may construct and/or utilize graphs. For example, as part of graph construction, a graph architecture (or structure) may be defined a priori. A graph may include, for example, identified connected nodes, edge attributes, object attributes, and/or global attributes. For example, some embodiments may construct a graph identified as G (V,E). Within the graph G, a given vertex (or node, such as fault 107 in FIG. 1) may be identified as vᵢ∈V. The vertex vᵢ may be anchored at a pixel location (xᵢ,yᵢ), such as a centroid of an object. The vertex vᵢ may be defined by a class object grouping a set of pixels. Within the graph G, a specific edge may be identified as eⱼ∈E. The edge eⱼ may be a function of (vₛ, vᵣ, rₖ), thereby defining the relationship of type rₖ from sending vertex vₛ to receiving vertex vᵣ.

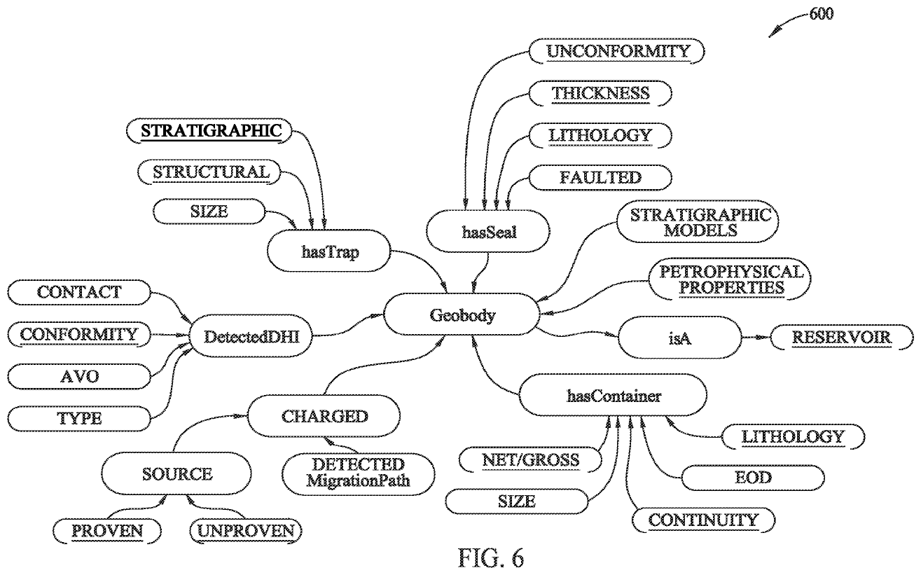

In some embodiments, a graph architecture may be based on geoscience ontology. As such, the graph architecture may allow an accurate prediction of the amount of hydrocarbons when processed by a graph network. For example, a geoscience ontology may organize the compositional nature of knowledge and/or reasoning about a hydrocarbon system. A geoscience ontology may include a set of geoscience concepts and categories that represents certain properties and the relationships between associated properties. An exemplary graph 400 relating objects identified from a seismic image is illustrated in FIG. 4. An exemplary ontology 600 for graph 400 is illustrated in FIG. 6. Based on the organization of ontology 600, a graph network may infer new information from an input of structured data (e.g., based on geoscience ontology) using a set of weights (e.g., network parameters). For example, the weights may be determined by training. The network parameters may include node, edge parameters and types, global parameters and types, and/or accumulation function parameters and types.

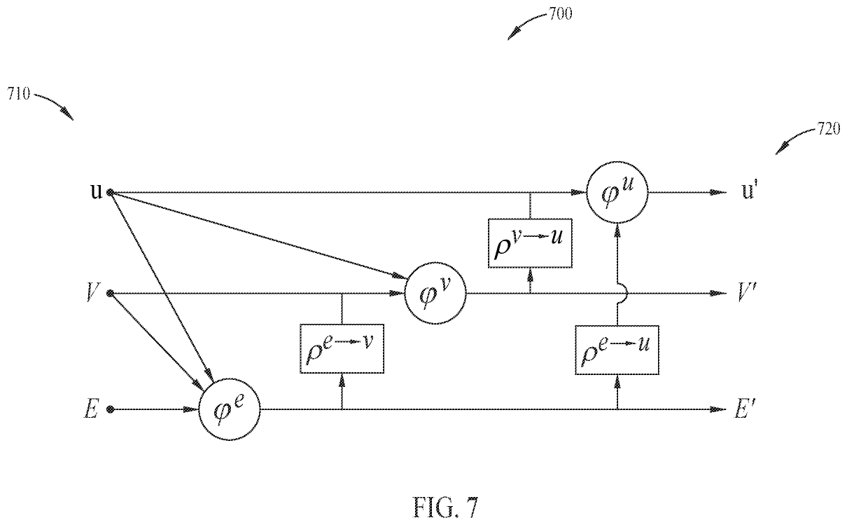

Some embodiments of the present disclosure utilize machine reasoning approaches based on graph networks. A graph network may be generally described as a computational framework for entity- and/or relation-based reasoning operating on graphs. An exemplary building block of a characteristic graph network 700 is illustrated in FIG. 7. Graph networks may utilize structured data to infer new information from this structured data. Computational frameworks for graph networks include, for example, graph neural networks, message-passing graphs, relational graphs, and graph autoencoders. More particularly, a graph neural network may be described as a connectionist model that captures the dependence(s) of graphs via message passing between the nodes of the graphs.

As illustrated in FIG. 7, graph network 700 operates on a graph, described by input 710, including structure and attributes {E,V,u}. Graph network 700 thereby produces output 720, including new attributes for the same graph, {E′,V′,u′}. Graph networks may be trained based on geoscientific knowledge to perform geological reasoning. For example, a trained graph network may predict the amount of hydrocarbon accumulations for each reservoir node as V′.

Embodiments disclosed herein may construct and/or utilize fully-connected graph structures. It should be appreciated that a fully-connected graph structure possesses many edges (e.g., Nᵥ² directed edges for Nᵥ nodes, including edges directed to a source node itself). At times, and in some implementations, some of the edges may not be useful for rating a hydrocarbon prospect and/or answering a question regarding a hydrocarbon system. Spurious edges may unintentionally deteriorate the predictive performance of the graph. Also, it should be appreciated that a fully-connected graph may be computationally expensive during the training and/or prediction (inference) operations. Consequently, in some embodiments, sparse graphs with geologically, geophysically and/or petrologically meaningful edges may be utilized.

In some embodiments, a sparse graph may be constructed based on geological and/or petrological considerations. For example, a sparse graph may be constructed based on a pixel-based prediction of shale- and/or sand-dominated strata (and their associated permeability fields, if available). Objects (e.g., shale and sand layers) may be extracted from the pixel-based predictions. Relationships may also be extracted. For example, if a sand layer touches another sand layer, the two layers may be connected with an edge indicating that two layers are in pressure communication. As another example, if a sand layer touches a shale layer such that the shale layer is “on top of” or “laterally adjacent to” the sand layer, the two layers may be connected with an edge indicating that the shale might be a seal to the sand layer.

In some embodiments, a graph may be constructed with object attributes based on geological and/or petrological considerations. Object attributes may include properties of the object, such as geometric properties (e.g., size, orientation, and shape), geophysical properties (e.g., reflectivity, amplitude versus offset, density, wave velocities, etc.), geological properties (geological age, EOD, etc.), and/or petrophysical properties (e.g., permeability, porosity, etc.). At least some of the attributes associated with a class of an object may be derived from a geoscience ontology, such as ontology 600 (see FIG. 6).

In some embodiments, object attributes may include properties of an object, such as a seismic image. For example, the object attribute may include an image of the object that may be resampled for computational efficiency. In some embodiments, resampling an image of an object may be performed without losing values such as shape and size.

In some embodiments, a graph may be constructed with edge attributes based on geological and/or petrological considerations. For example, edge attributes may describe relationships between a sending node (or vertex or object) vₛ and receiver node vᵣ. In some embodiments, edge attributes may include quantities such as relative geographical position.

In some embodiments, edge attributes may be related to paths in the subsurface, such as a potential hydrocarbon migration path. As illustrated in FIG. 3, hydrocarbon system 100 includes migration path 108 from a node labeled as vₛ to a node labeled as vᵣ. Migration path 108 may be represented as path pⁱ∈P, where P is the set of paths between objects vₛ and vᵣ. The edge 130 in FIG. 3 that is labeled as e may include edge attributes indicative of path pⁱ. Note that the presence of a potential hydrocarbon migration pathway is a key play element utilized in prediction of hydrocarbon presence.

In some embodiments, edge attributes related to potential hydrocarbon migration pathways may be constructed. For example, a plausible path may be constructed as a property-weighted shortest path between two objects. In particular, a property-weighted shortest path may be computed as the integral of a spatial property κ(x) along p,

F(p)=∫ₚκ(x)dx, (1)

where x is a spatial coordinate system, and dx is the length of a line segment in two dimensions, or the area of the surface segment in three dimensions. The property κ may be an estimate for a petrophysical quantity, such as permeability. The property-weighted shortest path may be computed as the path that minimizes the functional F,

$${p}^{*} = arg {min}_{p ∈ P} F ( p ) \qquad ( 2 )$$

A family of such plausible paths may also be determined by solving an Eikonal equation

|∇p(x)|=1/κ(x) and x∈Ω (3)

with boundary condition p|_{∂Ω}=0 over a subsurface domain Ω with boundary ∂Ω.

In some embodiments, when permeability is used as the weighting property, p* may be indicative of the migration pathway. For example, p* may be indicative of a specific edge between source 101 and reservoirs 109, 110, 111, 112 (see FIG. 1). In some embodiments the property κ may be a constant, in which case p* becomes the straight line between the two objects vₛ and vᵣ. In some embodiments, the quantities measured along the path might be the attribute of the edge.

In some embodiments, a structured representation model may learn to simultaneously identify many, most, or all of the elements that make up the subsurface or petroleum system and link them together. For example, a structured representation model (e.g., a neural network) may be trained to learn and/or define a graph (e.g., object attributes V and/or edge attributes E). In some embodiments, training the structured representation model may be end-to-end (e.g., learning both object detection and relationship simultaneously). In some embodiments, the structured representation model may be trained to determine the relationships (e.g., edge attributes E) by using already predicted objects (e.g., object attributes V). For example, a training network (e.g., an automated seismic interpretation model using a fully-convolutional network) may be utilized to train the structured representation model to detect objects (e.g., geologic and fluid objects) in a seismic image. In some embodiments, the training will allow the structured representation model to analyze the image and possible components of the graph when predicting on (V, E) or (E). If predictions involve both V and E, the model may both detect the object (or its attributes) and connect the detected objects.

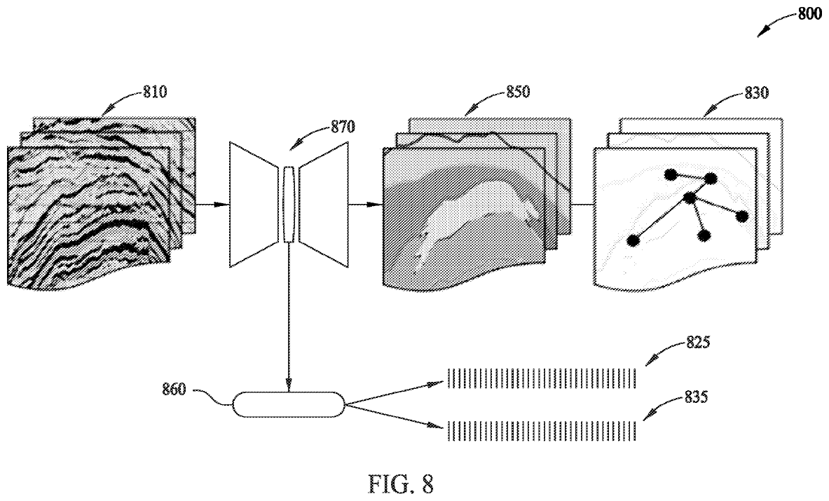

FIG. 8 illustrates a functional diagram of a system 800 that utilizes a structured representation model to simultaneously identify geologic objects and relationships thereamong. As illustrated, the system 800 takes as input seismic images 810. The seismic images 810, similar to hydrocarbon system 100 of FIG. 1, may represent the processed geophysical observations. Seismic images 810 may be representative of a subsurface volume. In some embodiments, a seismic survey may be conducted to acquire the seismic images 810 (noting that these and other embodiments may also or instead include obtaining other geophysical data in addition or, or instead of, seismic data—such as obtaining electrical resistivity measurements). In these and other embodiments, simulation models may be utilized to generate synthetic geophysical input data (e.g., computer simulation). In some embodiments, the input data may be obtained from a library of data from previous seismic surveys or previous computer simulations. In some embodiments, a combination of any two or more of these methods may be utilized to generate the initial data.

As illustrated in FIG. 8, structured representation models (e.g., neural networks) may utilize graphs to detect and/or represent geologic objects (and relationships thereamong) from seismic images. For example, structured image representation model 870 may be utilized to detect geologic objects in the input seismic images 810. The structured image representation model 870 may also be utilized to detect relationships among the detected objects. For example, the structured image representation model 870 may perform one or more of the tasks 850 illustrated in FIG. 5: semantic segmentation at block 502, instance segmentation at block 503, control feature detection at block 504, and relationship identification at block 505. In some embodiments, structured image representation model 870 may identify and/or label geologic objects (similar to nodes 120 of FIG. 3) and relationships (similar to edges 130 of FIG. 3) from the input seismic images 810, resulting in labeled images 830. The labeled images 830 may represent geologic features (or control features) and their connectivity for the subsurface volume in geographic space. In some embodiments, structured attribute representation model 860 may identify object attributes 825 (e.g., class, node ID, bounding box, etc.) and/or edge (relationship) attributes 835 (edge ID, source ID, destination ID, type, etc.) from the input seismic images 810 or form a latent space of structured image representation model 870. The object attributes 825 and edge attributes 835 may represent geologic features for the subsurface volume in attribute space, rather than in geographic space. Note that structured imaged representation model 870 and structured attribute representation model 860 may be trained simultaneously or separately.

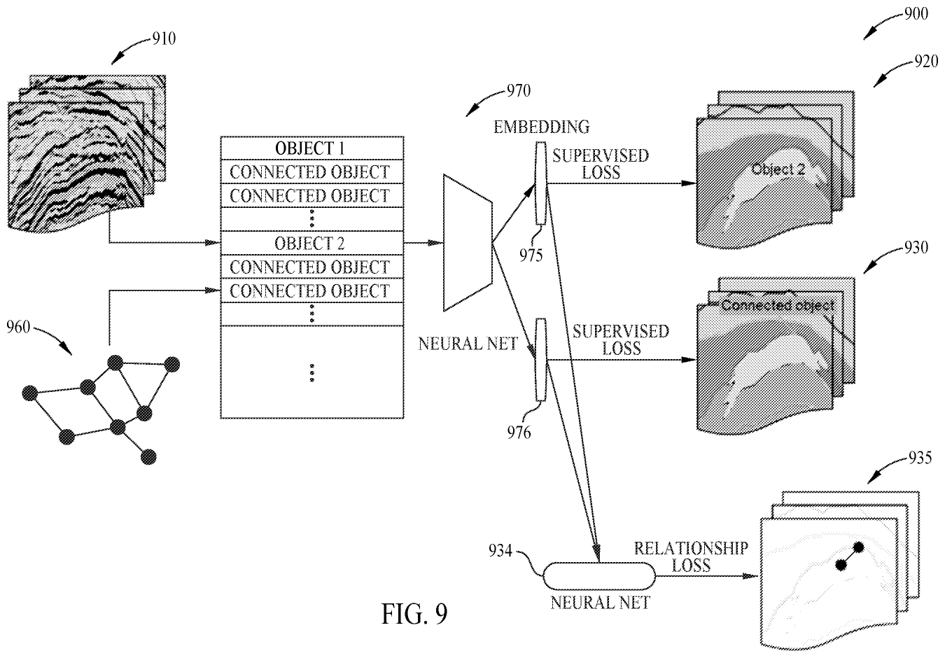

As illustrated in FIG. 9, structured representation models 900 (e.g., neural networks) may utilize embeddings to represent geologic objects and relationships thereamong. For example, structured representation model 970 may be utilized to detect geologic objects in the seismic images 910. The structured representation model 970 may also be utilized to detect relationships among the detected objects. For example, the structured representation model 970 may perform one or more of the tasks 850 illustrated in FIG. 5: semantic segmentation at block 502, instance segmentation at block 503, control feature detection at block 504, and relationship identification at block 505. In some embodiments, structured representation model 970 may identify and/or label geologic objects (similar to nodes 120 of FIG. 3) from the seismic images 910. For example, structured representation model 970 may identify and/or label geologic objects from the seismic images 910 by mapping the geologic objects to embedding space 975 or embedding space 976 (e.g., a structured representation space). In some embodiments, embedding space 975, 976 may be mapped to segmented objects, resulting in labeled images 920 or labeled images 930, respectively. As another example, structured representation model 934 may identify and/or label connections (similar to edges 130 of FIG. 3) between geologic objects from embedding space 975, 976 (e.g., a structured representation space). In some embodiments, structured representation model 970 may identify and/or label object attributes and/or edge attributes from the seismic images 910, resulting in labeled attributes 935. The labeled images 920, 930 may represent geologic features for the subsurface volume in geographic space. In some embodiments, structured representation model 970 may utilize a knowledge model 960 (e.g., a geoscience ontology, a set of geoscience rules, and/or a relational graph) to identify object attributes (e.g., class, node ID, bounding box, etc.) and/or edge attributes (edge ID, source ID, destination ID, type, etc.) from the seismic images 910. The labeled object attributes and/or edge attributes 935 may be extracted by attribute representation model 934 from embedding spaces 975, 976. The labeled attributes 935 may correspond to the attribute of the nodes and edges in the graph, rather than attributes in geographic space. As such, attribute representation model 934 may provide an implicit relational representation of the objects' relationships.

In some embodiments, a structured representation model may separately determine the instances of an object class and the connectivity. For example, a first structured representation model may be based on a convolutional neural network (CNN) for detecting the objects, while a second structured representation model may be based on a recurrent neural network (RNN) for determining the instances of an object class (e.g., grouping the pixels to identify control features or an entire object itself). Similar network architectures may be utilized to determine connectivity maps.

In some embodiments, training data for learning to identify the geologic objects and relationships thereamong may be based on domain experts' annotations. In some embodiments, training data for learning to identify the geologic objects and relationships thereamong may be based on geoscientific simulations (e.g., computational stratigraphy, geomechanics, geophysics, and/or petrophysics simulations). In some embodiments, training data for learning to identify the geologic objects and relationships thereamong may be based on both domain experts' annotations and geoscientific simulations.

In some embodiments, geologic segmentation (semantic segmentation) may be facilitated with the deep learning methods. For example, deep learning methods may classify pixels to segment the images. In some embodiments, geologic segmentation (semantic segmentation) may be facilitated with grouping the classified pixels to construct objects. For example, grouping the classified pixels to construct objects may be learned with another network (e.g., CNNs). Further, learning to group the classified pixels may include utilizing the segmented images as inputs, and generating the grouped pixels as output. In some embodiments, those object may be utilized for geoscientific simulations to train neural networks to recognize the relations among those objects, as illustrated in FIG. 8 and FIG. 9.

Those skilled in the art, with the benefit of this disclosure, may build a system to illustrate the utilization of this application for learning geological and/or petrological relationships among a number of geological and DHI objects from geoscientific simulations. An example may include a number of synthetic subsurface scenarios which may simulate flow of oil in water distributed in the subsurface with an initial condition of oil being contained in the source rock. This example may assume that the geological setting is static (no geomechanical or geological changes) during the simulations, and that only fluids move. This example may utilize saturation distributions of oil and water in the subsurface from those simulations along with seismic images to learn the relationships among hydrocarbon system elements such as source, reservoir, migration pathways including faults, traps, seals, and/or DHIs.

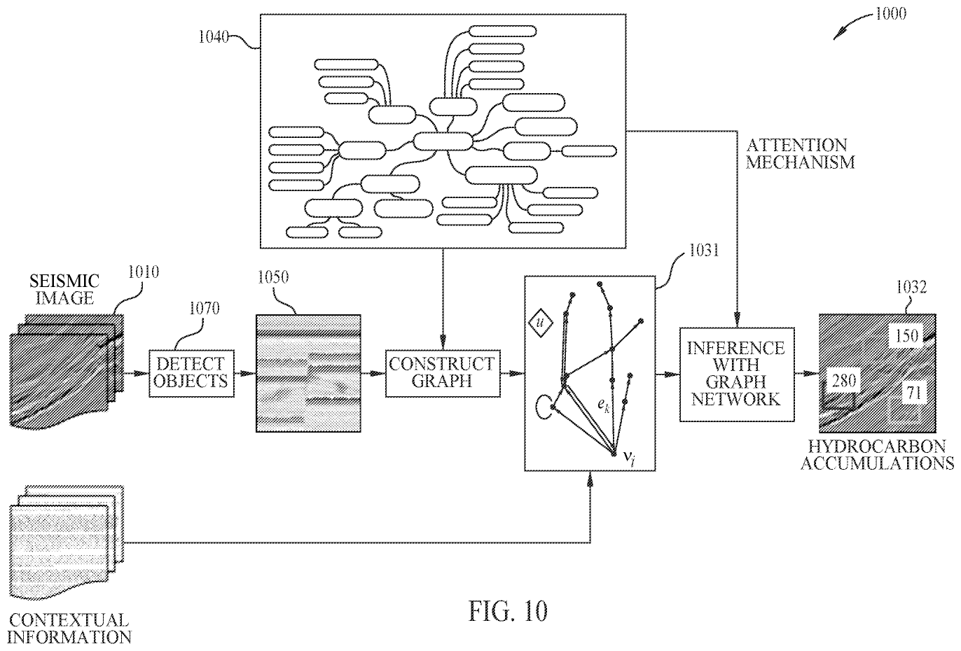

FIG. 10 illustrates a functional diagram of a geological reasoning system 1000 utilizing structured representations models. Inference performed by geological reasoning system 1000 may predict both the categorical identification of play elements and numeric estimation of hydrocarbon accumulation, or rating for the prospect. As illustrated, seismic images 1010, similar to hydrocarbon system 100 of FIG. 1, may represent geoscientific knowledge. Seismic images 1010 may be representative of a subsurface volume. A structured representation model 1070 (e.g., structured image representation model 870, structured representation model 970) may be utilized to identify objects and relationships in seismic images 1010, resulting in labeled images 1050, similar to geologic nodes 120 and edges 130 of FIG. 3. The labeled images 1050 may represent geologic features for the subsurface volume. A knowledge model 1040 (e.g., ontology 600 of FIG. 6) may be utilized with the labeled images 1050 to construct a structured representation 1031 (e.g., graph 200 of FIG. 2).

A trained graph network, similar to graph network 700 of FIG. 7, may be utilized to perform inference on objects of structured representation 1031. Inference with the graph network produces output graph 1032. By performing inference with geological reasoning system 1000, fewer training instances may be utilized than would be the case with pixel-based methods. Also, performing inference with geological reasoning system 1000 may generalize better (than pixel-based methods) to unseen examples.

In some embodiments, geological reasoning system 1000 may be adapted to include a recurrent graph network with an encoder and a decoder, and/or a message-passing graph network.

The output graph 1032 may provide, for example, predictions of the hydrocarbon accumulations for each reservoir object. For example, attributes of output graph 1032 may include probability-ranked categorical output, such as a confidence measure on the presence of play elements. As another example, attributes of output graph 1032 may include numerical quantities, such as porosity, or an estimate of the amount of hydrocarbon accumulations per reservoir object.

Geological reasoning with graph networks may be utilized for geological question answering. For example, performing inference with the trained graph network of geological reasoning system 1000 and/or output graph 1032 may be utilized to answer questions about the subsurface. Such questions may include, for example: What is the lithology of the subsurface (e.g., carbonate, sand, or volcanic)? What is the crest (e.g., elevation) of the trap? Is the reservoir connected to other reservoirs? Is there an anomalous amplitude consistent with hydrocarbons when compared to modeling of rock physics properties? Is there evidence of wet sands (i.e., good porosity, but no hydrocarbon indicator) below a direct hydrocarbon indicator? What is the resource density? Is there evidence (e.g., wells, seeps, shallow gas seismic hydrocarbon indicators) for a hydrocarbon system in the basin? What is the environment of deposition of the reservoir?

In practical applications, the present technological advancement may be used in conjunction with a seismic data analysis system (e.g., a high-speed computer) programmed in accordance with the disclosures herein. Preferably, in order to efficiently perform geological reasoning according to various embodiments herein, the seismic data analysis system is a high-performance computer (HPC), as known to those skilled in the art. Such HPCs typically involve clusters of nodes, each node having multiple CPUs and computer memory that allow parallel computation. The models may be visualized and edited using any interactive visualization programs and associated hardware, such as monitors and projectors. The architecture of the system may vary and may be composed of any number of suitable hardware structures capable of executing logical operations and displaying the output according to the present technological advancement. Those of ordinary skill in the art are aware of suitable supercomputers available from Cray or IBM.

As will be appreciated from the above discussion, in certain embodiments of the present approach, expert inputs are elicited that will have the most impact on the efficacy of a learning algorithm employed in the analysis, such as a classification or ranking algorithm, and which may involve eliciting a judgment or evaluation of classification or rank (e.g., right or wrong, good or bad) by the reviewer with respect to a presented query. Such inputs may be incorporated in real time in the analysis of seismic data, either in a distributed or non-distributed computing framework. In certain implementations, queries to elicit such input are generated based on a seismic data set undergoing automated evaluation, and the queries are sent to a workstation for an expert to review.

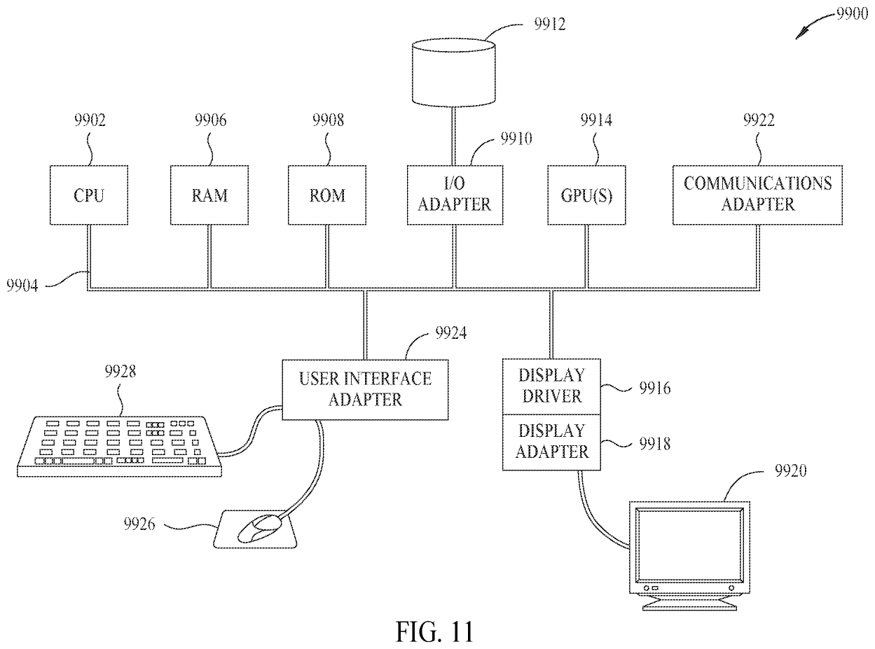

FIG. 11 illustrates a block diagram of a seismic data analysis system 9900 upon which the present technological advancement may be embodied. A central processing unit (CPU) 9902 is coupled to system bus 9904. The CPU 9902 may be any general-purpose CPU, although other types of architectures of CPU 9902 (or other components of exemplary system 9900) may be used as long as CPU 9902 (and other components of system 9900) supports the operations as described herein. Those of ordinary skill in the art will appreciate that, while only a single CPU 9902 is shown in FIG. 11, additional CPUs may be present. Moreover, the system 9900 may comprise a networked, multi-processor computer system that may include a hybrid parallel CPU/GPU system. The CPU 9902 may execute the various logical instructions according to various teachings disclosed herein. For example, the CPU 9902 may execute machine-level instructions for performing processing according to the operational flow described.

The seismic data analysis system 9900 may also include computer components such as non-transitory, computer-readable media. Examples of computer-readable media include a random access memory (RAM) 9906, which may be SRAM, DRAM, SDRAM, or the like. The system 9900 may also include additional non-transitory, computer-readable media such as a read-only memory (ROM) 9908, which may be PROM, EPROM, EEPROM, or the like. RAM 9906 and ROM 9908 hold user and system data and programs, as is known in the art. The system 9900 may also include an input/output (I/O) adapter 9910, a communications adapter 9922, a user interface adapter 9924, and a display adapter 9918; the system 9900 may potentially also include one or more graphics processor units (GPUs) 9914, and one or more display drivers 9916.

The I/O adapter 9910 may connect additional non-transitory, computer-readable media such as storage device(s) 9912, including, for example, a hard drive, a compact disc (CD) drive, a floppy disk drive, a tape drive, and the like to seismic data analysis system 9900. The storage device(s) may be used when RAM 9906 is insufficient for the memory requirements associated with storing data for operations of the present techniques. The data storage of the system 9900 may be used for storing information and/or other data used or generated as disclosed herein. For example, storage device(s) 9912 may be used to store configuration information or additional plug-ins in accordance with the present techniques. Further, user interface adapter 9924 couples user input devices, such as a keyboard 9928, a pointing device 9926 and/or output devices to the system 9900. The display adapter 9918 is driven by the CPU 9902 to control the display on a display device 9920 to, for example, present information to the user. For instance, the display device may be configured to display visual or graphical representations of any or all of the models discussed herein (e.g., graphs, seismic images, feature probability maps, feature objects, predicted labels of geologic features in seismic data, etc.). As the models themselves are representations of geophysical data, such a display device may also be said more generically to be configured to display graphical representations of a geophysical data set, which geophysical data set may include the models and data representations (including models and representations labeled with features predicted by a trained machine learning model) described herein, as well as any other geophysical data set those skilled in the art will recognize and appreciate with the benefit of this disclosure.

The architecture of seismic data analysis system 9900 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the system 9900 may include various plug-ins and library files. Input data may additionally include configuration information.

Seismic data analysis system 9900 may include one or more machine learning architectures, such as neural networks, graph neural networks, RNN, CNN, visual question answering system, etc. The machine learning architectures may be trained on various training data sets, e.g., as described in connection with various methods herein. The machine learning architectures may be applied to analysis and/or problem solving related to various unanalyzed data sets (e.g., test data such as acquired seismic or other geophysical data, as described herein). It should be appreciated that the machine learning architectures perform training and/or analysis that exceed human capabilities and mental processes. The machine learning architectures, in many instances, function outside of any preprogrammed routines (e.g., varying functioning dependent upon dynamic factors, such as data input time, data processing time, data set input or processing order, and/or a random number seed). Thus, the training and/or analysis performed by machine learning architectures is not performed by predefined computer algorithms and extends well beyond mental processes and abstract ideas.

The above-described techniques, and/or systems implementing such techniques, can further include hydrocarbon management based at least in part upon the above techniques. For instance, methods according to various embodiments may include managing hydrocarbons based at least in part upon geological reasoning graphs and graph networks constructed according to the above-described methods. In particular, such methods may include drilling a well, and/or causing a well to be drilled, based at least in part upon the output of a geological graph network (e.g., such that the well is located based at least in part upon a location determined from the output graph, which location may optionally be informed by other inputs, data, and/or analyses, as well) and further prospecting for and/or producing hydrocarbons using the well.

The foregoing description is directed to particular example embodiments of the present technological advancement. It will be apparent, however, to one skilled in the art, that many modifications and variations to the embodiments described herein are possible. All such modifications and variations are intended to be within the scope of the present disclosure, as defined in the appended claims.

1. A method comprising:
obtaining subsurface data for a subsurface region; and
extracting a structured representation from the subsurface data by:
identifying geologic and fluid objects in the subsurface data, wherein each object corresponds to a node of the structured representation; and
identifying relationships among the identified geologic and fluid objects, wherein each relationship corresponds to an edge of the structured representation.

2. The method of claim 1, wherein the structured representation is based on any of: graphs, embeddings, or a combination of graphs and embeddings.

3. The method of claim 2, wherein the identifying geologic and fluid objects utilizes a domain expert's annotations or a geoscientific simulation.

4. The method of claim 3, wherein the geologic and fluid objects comprise any of: a geologic trap, a fault, a reservoir, a source rock, a geologic seal, and direct hydrocarbon indicators.

5. The method of claim 4, wherein the relationships among the identified geologic and fluid objects comprise any of: geological relationships, geophysical relationships, and petrological relationships.

6. The method of claim 5, further comprising determining object attributes from the subsurface data.

7. The method of claim 6, further comprising determining edge attributes from the subsurface data;
wherein at least one edge attribute is related to a potential hydrocarbon migration path; and
wherein the at least one edge attribute comprises quantities measured along the potential hydrocarbon migration path.

8.-9. (canceled)

10. The method of claim 7, further comprising:
determining global attributes of the structured representation;
connecting the geologic and fluid objects to other related knowledge bases; and
answering a geological question with a question answering system.

11.-12. (canceled)

13. The method of claim 10, wherein the question answering system is a Visual Question Answering system.

14. The method of claim 10, further comprising receiving the geological question from a user.

15. The method of claim 14, further comprising inferring information from the structured representation of the subsurface data.

16. The method of claim 15, wherein inferring information comprises at least one of the following:
making an analog recommendation for hydrocarbon management;
predicting a confidence of hydrocarbon presence in the subsurface region;
geological reasoning; and
prospect rating and ranking.

17. The method of claim 16, wherein the structured representation comprises at least one of a graph and an embedding.

18. The method of claim 17, wherein extracting the structured representation utilizes a structured representation model.

19. The method of claim 18, wherein the structured representation model comprises a neural network.

20. The method of claim 19, wherein the neural network performs at least one of the following:
predicting attributes of nodes; and
predicting attributes of edges.

21. The method of claim 19, wherein the neural network is trained with at least one of the following:
a geoscientific simulation; and
a domain expert's annotations; and
wherein the geoscientific simulation comprises at least one of: a geophysical simulation, a petrophysical simulation, a process stratigraphy, and a geomechanical simulation.

22. (canceled)

23. The method of claim 19, wherein the neural network is a graph convolutional neural network.

24. The method of claim 23, further comprising sequentially identifying the geologic and fluid objects and the relationships utilizing a recurrent neural network decoding sequential creation of the geologic and fluid objects.

25. The method of claim 24, further comprising modeling the objects based on spatial relationships.

26. The method of claim 25, further comprising inferring the objects based on Markov Random Field methods or Conditional Random Field methods.

27. The method of claim 26, wherein the subsurface data comprises one or more of the following:
seismic images;
electromagnetic images;
well measurements;
analog data;
knowledge bases;
related geological and petrological information; and
related field performance data.

28. The method of claim 27, wherein the subsurface data additionally includes auxiliary information pertaining the subsurface region; and
wherein the auxiliary information comprises text documents.

29. (canceled)

30. The method of claim 28, wherein related field performance data comprises one or more of oil-in-place, gas-oil-ratio, production rates, and a recovery factor.
